(19) United States
(12) Patent Application Publication
(10) Pub. No.: US 2026/0170836 A1
(43) Pub. Date: Jun. 18, 2026

(54) SYSTEMS AND METHODS FOR MACHINE LEARNING BASED ANALYSIS OF RACE CAR PIT CREW

(71) Applicants: Constructor Technology AG, Schaffhausen (CH); Constructor Education and Research Genossenschaft, Schaffhausen (CH)

(72) Inventors: Sergey ULASEN, Singapore (SG); Andrei BOIAROV, Sofia (BG); Alexander TORMASOV, Busingen am Hochrhein (DE); Artem SHAPIRO, Dnipro (UA); Serg BELL, Singapore (SG); Stanislav PROTASOV, Singapore (SG); Nikolay DOBROVOLSKIY, Alanya (TR); Laurent DEDENIS, Geneve (CH)

(21) Appl. No.: 18/981,886

(22) Filed: Dec. 16, 2024

(51) Int. Cl. G06V 20/52; G06V 10/764; G06V 20/40

(52) U.S. Cl. CPC G06V 20/52; G06V 10/764; G06V 20/42; G06T 2207/30232; G06V 2201/08

(57) ABSTRACT

Disclosed herein are systems and method for monitoring race car pit crews and generating optimization recommendations. In one aspect, a method includes: receiving, from at least one camera, a video clip of a crew member performing service of a race car; detecting, using a machine learning algorithm, an error made by the crew member while performing the service; in response to determining that the error has been performed by the crew member more than a threshold number of times within a period of time, identifying a sequence of events leading up to the error; generating, using the machine learning algorithm, a recommended change in the sequence to prevent the error from reoccurring in a future service; and transmitting an instruction including the recommended change to a communicative device of the crew member.

### FIELD OF TECHNOLOGY

The present disclosure relates to the field of machine learning, and, more specifically, to systems and methods for monitoring race car pit crews and generating optimization recommendations using machine learning.

### BACKGROUND

Race car pit crews need to be “finely-tuned machines” in motorsports as they execute precise actions with split-second timing. Every member of the crew has a designated role, from tire changers and fuelers to mechanics and strategists, all working in synchronized harmony to minimize the car's time off the track. Crews require speed and precision, where mechanics must change tires, refuel the car, make quick adjustments, and sometimes even repair damage in a matter of seconds. Each movement is rehearsed countless times to ensure efficiency, as even the smallest delay can cost valuable positions in a race where milliseconds determine success.

Despite their expertise, pit crews constantly seek optimization in their actions. Techniques evolve, equipment improves, and strategies are refined with each race. One area for enhancement lies in reducing pit stop times further without compromising safety or accuracy. Innovations in tools and technology play a crucial role, such as lightweight, high-performance jacks and faster refueling systems. Moreover, improving communication and coordination among team members can shave off precious fractions of a second. Analyzing data from each pit stop allows crews to identify bottlenecks and inefficiencies, driving continuous improvement in their performance.

### SUMMARY

In one exemplary aspect, the techniques described herein relate to a method for machine learning based analysis of a race car pit crew, the method including: receiving, from at least one camera, a video clip of a crew member performing service of a race car; detecting, using a machine learning algorithm, an error made by the crew member while performing the service; in response to determining that the error has been performed by the crew member more than a threshold number of times within a period of time, identifying a sequence of events leading up to the error; generating, using the machine learning algorithm, a recommended change in the sequence to prevent the error from reoccurring in a future service; and transmitting an instruction including the recommended change to a communicative device of the crew member.

In some aspects, the techniques described herein relate to a method, wherein the machine learning algorithm includes a large language model that outputs the recommended change in a text format.

In some aspects, the techniques described herein relate to a method, wherein the recommended change is visually output on the communicative device as one of an augmented reality object, virtual reality object, or a mixed reality object.

In some aspects, the techniques described herein relate to a method, wherein detecting the error includes detecting one or more of: a malfunctioning tool, a dropped tool, an injury, improper placement of car part, improper positioning of the crew member, improper positioning of the race car.

In some aspects, the techniques described herein relate to a method, wherein the machine learning algorithm is configured to detect a plurality of objects in the video clip, wherein the objects include one or more of the race car, a car part of the race car, the crew member, a tool used by the crew member.

In some aspects, the techniques described herein relate to a method, wherein the crew member is presented with a plurality of instructions to perform the service, and wherein transmitting the instruction includes one of: replacing an existing instruction in the plurality of instructions with the instruction; adding the instruction to the plurality of instructions; or modifying the existing instruction to match the instruction.

In some aspects, the techniques described herein relate to a method, further including: detecting whether the recommended change is executed by the crew member in the future service of the race car; evaluating whether the error was made by the crew member; and in response to determining that the error was made again by the crew member, generating another recommended change.

In some aspects, the techniques described herein relate to a method, wherein the recommended change includes one or more of: a tool change, a positional change, a technique change, a crew member reassignment, a crew member replacement, an exercise.

It should be noted that the methods described above may be implemented in a system comprising a hardware processor. Alternatively, the methods may be implemented using computer executable instructions of a non-transitory computer readable medium.

In some aspects, the techniques described herein relate to a system for machine learning based analysis of a race car pit crew, including: at least one memory; at least one hardware processor coupled with the at least one memory and configured, individually or in combination, to: receive, from at least one camera, a video clip of a crew member performing service of a race car; detect, using a machine learning algorithm, an error made by the crew member while performing the service; in response to determining that the error has been performed by the crew member more than a threshold number of times within a period of time, identify a sequence of events leading up to the error; generate, using the machine learning algorithm, a recommended change in the sequence to prevent the error from reoccurring in a future service; and transmit an instruction including the recommended change to a communicative device of the crew member.

In some aspects, the techniques described herein relate to a non-transitory computer readable medium storing thereon computer executable instructions for machine learning based analysis of a race car pit crew, including instructions for: receiving, from at least one camera, a video clip of a crew member performing service of a race car; detecting, using a machine learning algorithm, an error made by the crew member while performing the service; in response to determining that the error has been performed by the crew member more than a threshold number of times within a period of time, identifying a sequence of events leading up to the error; generating, using the machine learning algorithm, a recommended change in the sequence to prevent the error from reoccurring in a future service; and transmitting an instruction including the recommended change to a communicative device of the crew member.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for monitoring race car pit crews and generating optimization recommendations.

FIG. 2 is a diagram illustrating a view of a race car pit crew being captured by a plurality of cameras.

FIG. 3 is a diagram illustrating a recommendation of a different motion(s) to perform to a crew member.

FIG. 4 is a flow diagram of a method for machine learning based analysis of a race car pit crew.

FIG. 5 presents an example of a general-purpose computer system on which aspects of the present disclosure can be implemented.

### DETAILED DESCRIPTION

Exemplary aspects are described herein in the context of a system, method, and computer program product for monitoring race car pit crews and generating optimization recommendations using machine learning. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

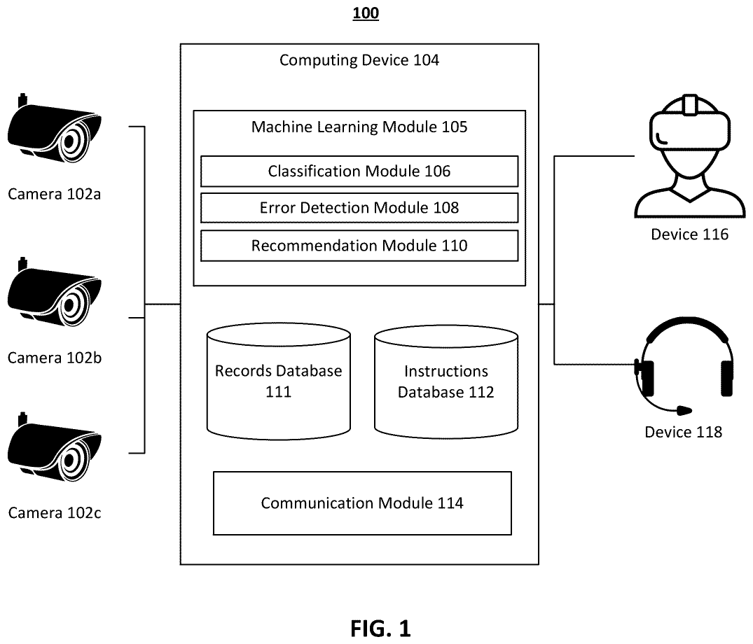

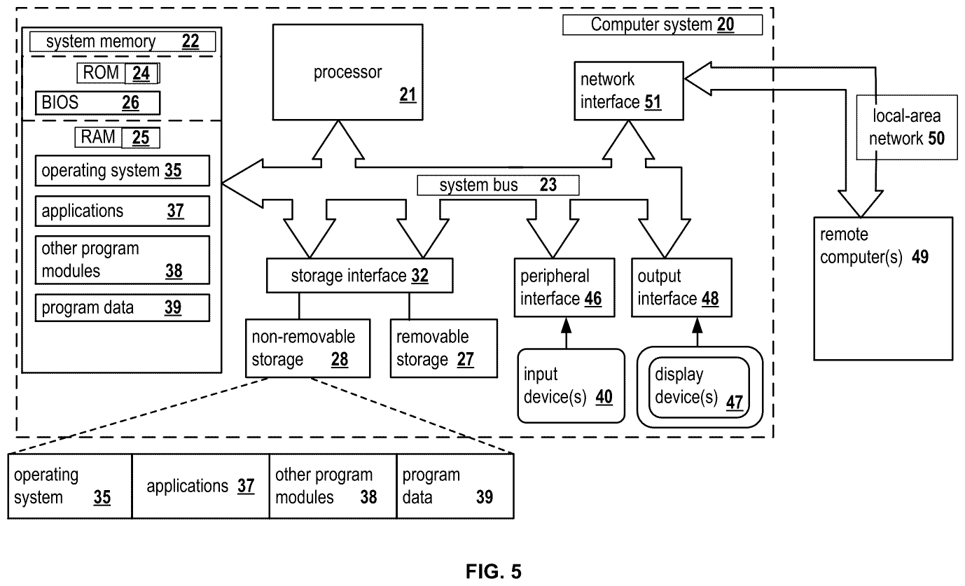

FIG. 1 is a block diagram illustrating a system 100 for monitoring race car pit crews and generating optimization recommendations. System 100 includes a plurality of cameras 102 (e.g., camera 102a, camera 102b, camera 102c) connected to a computing device 104 (e.g., computer system 20 described in FIG. 5). For example, computing device 104 may be a server that receives footage from cameras 102. Although only three cameras are shown in FIG. 1, one skilled in the art will appreciate that any number of cameras may be used. In some aspects, there may be one camera for each crew member. In some aspects, a camera may be fixed in a particular location of the racing environment. In some aspects, a camera may be a body camera worn by a crew member.

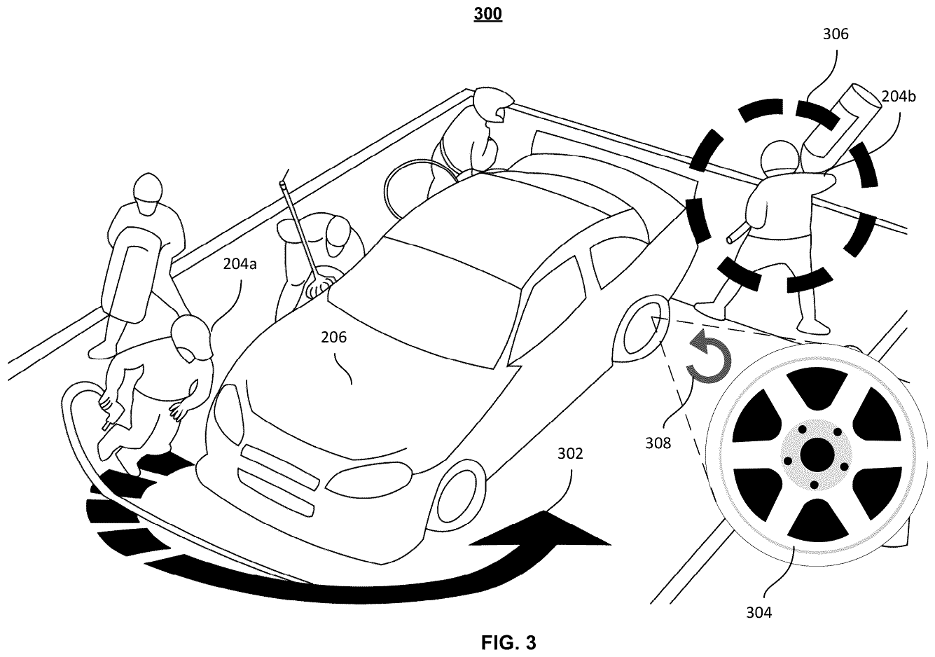

Computing device 104 may execute a plurality of modules that together make up an analysis and recommendation system. For example, computing device 104 may execute machine learning module 105, which includes classification module 106, error detection module 108, and recommendation module 110. Computing device 104 may further execute communication module 114. Recommendation module 110 may generate crew member instructions that are stored in instructions database 112. Crew members may utilize headsets and/or headphones (e.g., device 116, device 118) to communicate with one another and receive instructions from recommendation module 110. For example, if an instruction involves running towards the car in a particular motion, recommendation module 110 may generate a visual arrow (e.g., as shown in FIG. 3) that may be displayed to the designated crew member via device 116 (e.g., a mixed reality headset).

During a pitstop in a race car event, crew members perform various tasks in a synchronized and efficient manner to ensure that the car can return to the race as quickly as possible. The typical tasks performed by crew members during a pitstop may include:

Tire Changing: Crew members remove worn tires and replace them with fresh ones. This involves using pneumatic tools (such as air guns) to quickly loosen and tighten lug nuts.

Refueling: In races where refueling is allowed, crew members connect a fuel hose to the car's fuel tank and fill it up with the required amount of fuel for the next stint.

Driver Assistance: The driver might need adjustments to their seatbelts, communication equipment, or even a drink if it's a long race. Crew members assist the driver with any necessary adjustments or replenishments.

Car Inspection: A quick visual inspection of the car's exterior and sometimes underbody to check for damage or any potential issues that need immediate attention.

Adjustments: Depending on race conditions or the driver's feedback, adjustments might be made to the car's suspension, wing angles, or other settings to optimize performance for the next stint.

Data Collection: Some teams use this opportunity to download data from the car's onboard systems to analyze the performance and make strategic decisions for the remainder of the race.

Cleaning: Crew members might clean the windshield or remove any debris from the car to ensure visibility and aerodynamic efficiency are maintained.

Safety Checks: Before the car leaves the pit lane, crew members ensure that all equipment (such as jacks and air hoses) is clear of the car, and that it is safe to re-enter the race.

System 100 monitors how crew members do their job and is configured to improve safety, increase speed of service, reduce errors, etc. In an exemplary aspect, footage from cameras 102 is analyzed to detect key moments and tasks. For example, classification module 106 may first identify various objects (e.g., the car, crew members, wheels, air guns, car jack, nuts/bolts, fuel gun, etc.) in the captured footage using a machine learning algorithm (e.g., an image classifier). Classification module 106 may further assign an identifier to each object in a given video frame for tracking purposes. For example, a specific crew member may be assigned the identifier crew_member_01, and may be tagged on the video frame with the identifier. As the crew member travels across multiple frames, the identifier remains assigned to the crew member.

In addition to identifying objects, classification module 106 is configured to identify different motions and classify the tasks associated with the motions using a machine learning algorithm (e.g., a gesture/motion classifier). For example, if a car enters a video frame, the motion may be classified as the initiation of a pitstop service. When a car exits the video frame, the motion may be classified as the end of the pitstop service. Each motion may be captured in a separate video clip.

Consider the motions involved with changing a tire. Based on the motions detected in one or more video clips, classification module 106 may classify the following tasks: (1) insert a jack and raise a car, (2) remove wheel bolts in clockwise motion, (3) remove the old wheel, (4) install a new wheel, (5) screw wheel bolts in clockwise motion, (6) remove the jack and lower the car. Classification module 106 may detect a motion, assign the task (e.g., remove wheel bolts in clockwise motion), and further output the time required to perform the task (e.g., 5.5 seconds).

Error detection module 108 is configured to analyze the video clips and detect potential errors or safety hazards using a machine learning algorithm (e.g., a model configured to detect known events such as dropped tools). Error detection module 108 may analyze the performance of the driver. For example, when the car enters the pitstop, error detection module 108 may determine whether the car as stopped at the ideal location. If the car stops too early or too late, the operation of the crew members may be delayed (e.g., because they have to run towards to the car in an unideal area).

Error detection module 108 may further analyze the performance of each crew member. For example, error detection module 108 may detect whether tools were dropped, tools were in the improper hand, whether the body position of the crew member was correct (e.g., squatting instead of tilting), whether one crew member is too fast or too slow, whether alignment was incorrect (e.g., incorrectly placed wheel), etc. Error detection module 108 may further detect whether a tool was not ready (e.g., absence of wheels in the right position to initiate wheel change), whether a task was skipped, whether a task took too long (e.g., fueling).

Error detection module 108 may further analyze the performance of each tool. For example, if an air gun or fuel gun takes longer than average to screw/unscrew or fuel, error detection module 108 may detect a faulty tool.

Classification module 106 and error detection module 108 may each utilize a deep 3D convolutional neural network (e.g., from the X3D family). Alternatively, 2.5D convolutional neural network approach can be used. In this scenario 2D convolutional neural network is used to extract embedding vectors from each frame of the input clip. Then temporal network (U-Net or Transformer type of architecture) is used to combine extracted embeddings and produce final decision. The input of the neural network may be a video clip and the output may be the classifications in the clip (e.g., the depicted objects, the tasks performed, the errors detected).

Error detection module 108 further identifies the tasks/events that involved errors and generates a sequence of events leading to said error. For example, if the error involves delayed unscrewing of a wheel, error detection module 108 may identify the video clip in which the error was detected. Suppose that while unscrewing a bolt, the air gun was dropped. Perhaps the air gun was dropped in multiple different occasions while unscrewing the bolts across different pitstop services. Error detection module 108 may retrieve the clip(s) in which the dropped air gun(s) were detected. Error detection module 108 may then execute a machine learning algorithm (e.g., an event classifier and sequence generator) to detect a plurality of events leading up to the error. In some aspects, error detection module 108 may generate a sequence comprising at least three events before the error. For example, a first event may be that a top most bolt was unscrewed. A second event may be that a second bolt to the right of the top most bolt was unscrewed, etc. Suppose that because the crew member is left handed, the momentum of unscrewing bolts in a clockwise direction causes him/her to drop the air gun when the left arm is fully extended (e.g., ⅓ way around the wheel). If this is a repeated error, it needs to be addressed.

It should be noted that the motions/events described in the present disclosure are heavily simplified. One skilled in the art will appreciate that the machine learning algorithms utilized may have significantly large datasets with highly specific details. For example, one motion may be captured as a series of vectors that specifically categorizes how high an arm was raised, the angled created by the elbow, the change in position of the arm, etc. Accordingly, a sequence of events may have 100 events for a 10 second video clip, each event indicating the precise movement of a body part (for example). This analysis would be beyond the capabilities of the human mind because the amount of data to be processed within the span of a pitstop service is unfathomable. Even the slightest change in positioning of tool can expedite or slow down the service. System 100 is configured to identify these nuances and make precise recommendations.

The sequences and classifications may be stored in records database 111, which is used to gather statistics about the events. For example, a one-off error may not need correction. One a technical level, if the error is repeated more than a threshold number of times (e.g., wheel changing involves too many cases of slow wheel changing, misalignment, dropped air guns, etc.), then recommendation module 110 may recommend a change (e.g., a different motion for the crew member to unscrew the bolts).

Recommendation module 110 may analyze the statistics in the records database 111 and may generate recommendations for the crew member(s) involved with a repeated error. For example, for the dropped air gun error, recommendation module 110 may recommend that the crew member unscrew bolts in a counter clockwise path (rather than the clockwise path). In some aspects, recommendation module 110 may use a large language model (LLM) for generation and delivery of recommendations. In this case, the input to the module may be a report with all founded events, timings, crew positions on the track. Recommendation module 110 may collect a dataset with recommendations for performance-increasing from professionals and fine-tune the LLM to produce more accurate recommendations.

In some aspects, recommendations may involve motional changes (e.g., approach the car from left side instead of right, unscrew in a counter clockwise path instead of a clockwise path), task reassignments (e.g., give task to a different crew member), positional changes (e.g., stop the car in a particular area), physical changes (e.g., recommending exercises to crew members to improve physical tasks), tool changes (e.g., replace air gun with a new model), etc.

Recommendation module 110 may deliver a recommendation to a crew member in the form of an instruction (e.g., unscrew bolts in counterclockwise motion). Suppose that a crew member is given a plurality of instructions to perform a particular portion of a pitstop service. For example, the crew member may wear device 116, which is a mixed reality headset, that outputs the tasks to be performed in a tire change. The user interface displayed on device 116 may list the tasks (as instructions) or present visuals that guide the user to perform the tasks. In some aspects, these tasks/instructions are stored in instructions database 112. Each entry in instructions database 112 includes an instruction, a sequence number, and the identifier of the crew member for which the instruction is meant for. Recommendation module 110 may modify, remove, or add instructions in instructions database 112. For example, in the sequence for unscrewing the wheel, the crew member that consistently drops the air gun may have his/her instructions modified. Accordingly, when presented via device 116, the crew member knows how to perform the task.

Communication module 114 identifies each instruction in instructions database 112 and identifies the device that needs to receive the instruction. For example, the instructions database 112 may indicate the identifier of the crew member for which an instruction is meant for, and may, transmit the instruction to the device of the crew member.

As mentioned previously, the motions and events captured by system 100 may be highly detailed. Accordingly, recommendation module 110 may have highly nuanced instructions. For example, if a crew member extends his arm 100% to unhook a wheel, recommendation module 110 may recommend reducing the extension to generate greater torque. In some aspects, recommendation module 110 may recommend specific motions and body positions, and provide visuals on how to achieve the recommendations.

In general, machine learning module 105 may comprise one or more machine learning algorithms, which can broadly be categorized into three main types: supervised learning, unsupervised learning, and reinforcement learning.

Supervised learning is effective for tasks such as classification (assigning inputs to predefined categories) and regression (predicting continuous values). It relies on the availability of labeled data for both training and evaluation phases. In supervised learning, machine learning module 105 trains the algorithm on a labeled dataset, where each input has a corresponding output. The goal is to learn a mapping function from inputs to outputs, allowing the algorithm to make predictions or classifications on new, unseen data. The process typically involves the following steps: training, model building, prediction, feedback, and adjustment. In the training phase, machine learning module 105 provides the algorithm with a training dataset including input-output pairs. The algorithm learns the mapping function that relates inputs to outputs through an iterative process, adjusting its internal parameters based on the provided examples. During model building, the algorithm creates a model that can generalize from the training data to make predictions on new, unseen data. The model's complexity varies based on the algorithm used. For example, the model may be a simple linear regression model or a complex neural network. During the prediction phase, machine learning module 105 inputs test inputs (i.e., inputs with known outputs) into the model, which generates predictions or classifications based on what it has learned during training. The accuracy of predictions is evaluated by comparing them to the known outputs in a validation or test dataset. During the feedback and adjustment phase, machine learning module 105 refines the model based on feedback from its predictions. If the predictions differ from the actual outputs, the algorithm adjusts its internal parameters to minimize the errors. The performance of the trained model is assessed using metrics such as accuracy, precision, recall, etc., depending on the nature of the problem.

Unsupervised learning is valuable for tasks where the goal is to explore the inherent structure of the data, identify hidden patterns, or pre-process data for further analysis. It doesn't require labeled examples but relies on the algorithm's ability to discern meaningful structures within the input data. Unsupervised learning deals with unlabeled data, aiming to discover patterns, structures, or relationships within the dataset. Clustering and dimensionality reduction are common tasks in unsupervised learning, helping to reveal inherent structures without predefined target labels. The typical process for unsupervised learning includes: data collection, analysis (e.g., using clustering, dimensionality reduction, etc.) and association. For example, machine learning module 105 receives a dataset including only input features without corresponding output labels. Machine learning module 105 then performs exploratory data analysis to understand the inherent structure of the data. Common techniques in this analysis include statistical measures, clustering, and dimensionality reduction. For example, in clustering, the algorithm groups similar data points together based on certain features. Algorithms including, but not limited to, k-means clustering and hierarchical clustering are commonly used for grouping. In dimensionality reduction, the algorithm reduces the number of input features while retaining essential information. For example, the algorithm may use techniques like Principal Component Analysis (PCA) or t-distributed Stochastic Neighbor Embedding (t-SNE) for dimensionality reduction. During the association phase, the algorithm discovers relationships or associations between variables in the analyzed data. In some aspects, unsupervised learning is used in generative neural networks (e.g., generative adversarial networks (GANs)) to generate new data points similar to the existing dataset once the characteristics of the existing dataset are learned.

In machine learning, training involves optimizing the model's parameters to minimize a chosen objective function, often a loss function. Some training formulas and concepts that machine learning module 105 may execute include linear regression loss, logistic regression loss, reinforcement learning, and neural network loss.

For linear regression, Mean Squared Error (MSE) is a common loss function.

$$MSE = \frac{1}{n} {\sum }_{i = 1}^{n} {( {y}_{i} - {\hat{y}}_{i} )}^{2} ,$$

where yi is the true output, y\hat{ }i is the predicted output, and n is the number of samples.

For binary classification in logistic regression, the Binary Cross-Entropy Loss is frequently used.

$$Binary Cross - Entropy = - \frac{1}{n} {\sum }_{i = 1}^{n} [ {y}_{i} log ( {y}_{i} ) + ( 1 - {y}_{i} ) log ( 1 - {\hat{y}}_{i} ) ] ,$$

where yi is the true label (0 or 1), y\hat{ }i is the predicted probability, and n is the number of samples.

In neural networks, the cross-entropy loss is common for classification tasks.

$$Cross - Entropy = - \frac{1}{n} {\sum }_{i = 1}^{n} {\sum }_{j = 1}^{C} {y}_{ij} log ( {\hat{y}}_{ij} ) ,$$

where yij is the true probability of class j, y\hat{ }ij is the predicted probability, n is the number of samples, and C is the number of classes.

These formulas represent the core optimization objectives in different machine learning scenarios, and the choice depends on the specific task and model architecture.

Machine learning module 105 may comprise one or more neural networks, which are a class of machine learning models inspired by the structure and functioning of the human brain. They consist of interconnected nodes, called neurons or artificial neurons, organized into layers. Neural networks are capable of learning complex patterns and representations from data. The neural network executed by machine learning module 105 may be one of the following: a feedforward neural network (FNN), convolution neural network (CNN), recurrent neural network (RNN), long short-term memory (LSTM) network, gated recurrent unit (GRU) network, autoencoder, generative adversarial network (GAN).

An FNN is the simplest form of neural network, where information travels in one direction—from the input layer through hidden layers to the output layer. An FNN is commonly used for tasks like classification and regression.

A CNN is specialized for processing grid-like data, such as images, and employs convolutional layers to learn spatial hierarchies of features, reducing the need for manual feature engineering. CNNs are well-suited for tasks like image classification, object detection, and image generation.

An RNN is designed for sequential data, where the order of inputs matters. An RNN includes loops in the network architecture to allow information to persist, and is useful for tasks like natural language processing, speech recognition, and time-series prediction.

A LSTM network is an extension of an RNN designed to overcome the vanishing gradient problem. LSTMs have memory cells that can store and retrieve information over long sequences, making them effective for capturing long-term dependencies in sequential data.

A GRU Network is similar to LSTMs and are another type of RNN with mechanisms to address the vanishing gradient problem. GRUs have a simpler architecture with fewer parameters compared to LSTMs.

An autoencoder is a type of neural network used for unsupervised learning and dimensionality reduction, and consists of an encoder that compresses input data into a lower-dimensional representation (encoding) and a decoder that reconstructs the original input from the encoding.

A GAN comprises a generator and a discriminator trained simultaneously through adversarial training. The generator aims to generate realistic data, while the discriminator tries to distinguish between real and generated data. A GAN is widely used for image and content generation tasks.

In some aspects, recommendation module 110 utilizes reinforcement learning, in which the optimal decision-making strategy is learned through trial and error, without explicit guidance. Reinforcement learning involves an agent learning to make decisions by interacting with an environment. The agent receives feedback in the form of rewards or penalties based on its actions, allowing it to learn optimal strategies through trial and error. The primary components of reinforcement learning are as follows: agent, environment, state, action, reward, exploration and exploitation, learning policy, and value function. An agent is the entity that takes actions in the environment. It is the learner in the system. The environment is the external system with which the agent interacts. The external system provides feedback to the agent based on the actions taken. The state is a representation of the current situation or configuration of the environment. Actions are the moves or decisions that the agent can take within the environment. A reward is a numerical signal that indicates the immediate benefit or cost of the agent's action. The agent's objective is to maximize the cumulative reward over time. The reinforcement learning process typically involves the following steps. The agent explores the environment to discover the most rewarding actions (exploration) and exploits its current knowledge to take actions it believes will yield the highest cumulative reward (exploitation). The agent learns a policy, which is a strategy that maps states to actions, based on the observed rewards and its exploration-exploitation trade-offs. The agent may also learn a value function, estimating the expected cumulative reward from a given state or state-action pair.

In reinforcement learning, the objective is often to maximize the expected cumulative reward. The Q-learning update rule is an example:

$$Q ( s , a ) ← Q ( s , a ) + α [ r + γ {max}_{{a}^{′}} Q ( {s}^{′} , {a}^{′} ) - Q ( s , a ) ] ,$$

where Q(s, a) is the action-value function, α is the learning rate, r is the immediate reward, γ is the discount factor, s′ is the next state, and a′ is the next action.

In recommendation module 110, the objective is to minimize both the errors that take place in a service when a race car enters the pit stop and the time it takes to complete the service. The instructions recommended by the recommendation module 110 are the actions taken to achieve the objective. For example, recommendation module 110 may analyze performance of the instructions over a plurality of services performed. In a first service, recommendation module 110 may analyze the crew members and make a recommendation (i.e., take an action). In a subsequent service, when the action is executed, recommendation module 110 may determine whether the service time and number of errors went down. If so, the action was successful and another action can be recommended accordingly (e.g., an action that complements the successful action). If not, the action was unsuccessful and another action can be recommended accordingly (e.g., an action that does not complement the unsuccessful action). It should be noted that this action/monitoring process may take place over several races as well. Different environmental factors such as weather, crew member work schedules, car health, driver experience, etc., may impact the objective.

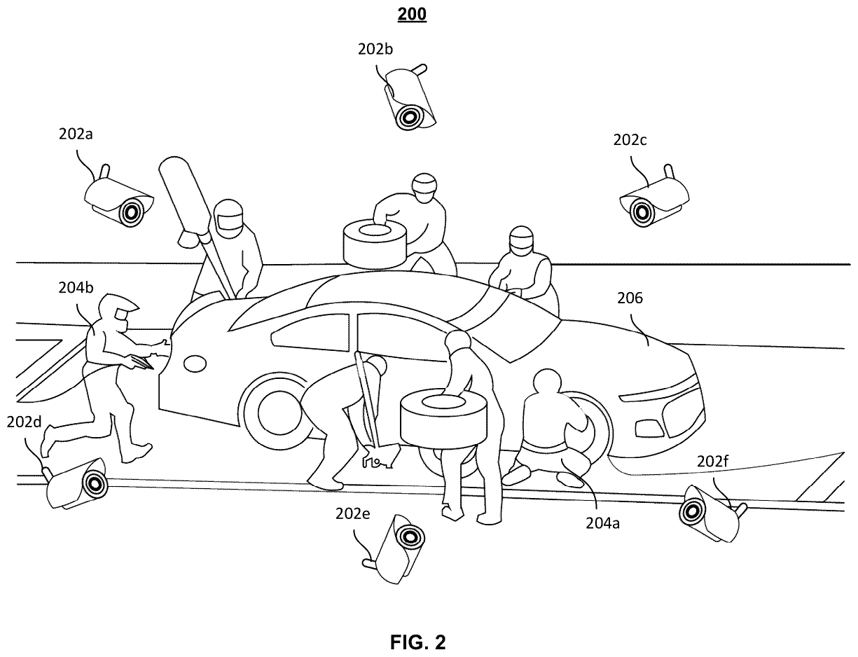

FIG. 2 is a diagram 200 illustrating a view of a race car pit crew being captured by a plurality of cameras. In diagram 200, cameras 202 (e.g., 202a, 202b, 202c, 202d, 202e, and 202f) are fixed in different parts of the environment. Each camera captures a different view of the service performed at the pitstop. It should be noted that diagram 200 may include other cameras that are not shown (e.g., body cameras worn by the crew members). When car 206 enters the pit stop, a plurality of crew members initiate the service. Suppose that crew member 204a and 204b are assigned with the task to replace tires. As shown in diagram 200, crew member 204a is positioned to replace the front tire. Crew member 204b is approaching a rear tire with an air gun. System 100 may analyze the performance of these crew members and detect any errors.

FIG. 3 is a diagram 300 illustrating a recommendation of a different motion(s) to perform to a crew member. Referring to diagram 200, suppose that after completing a wheel change of the front tire, crew member 204a moves to the front wheel on the opposite side. Suppose that normally crew member 204a runs towards and around the back of car 206. Recommendation module 110 may recommend movement 302, in which crew member 204a runs toward and around the front of car 206 (as shown in diagram 300). This may help crew member 204a avoid obstacles (e.g., other crew members or tools), minimize travel distance, and may ultimately reduce the time to reach the tire to be replaced.

Suppose that crew member 204b has dropped an air gun a threshold number of times when changing a wheel (specifically when unscrewing bolts). After dropping the air gun yet again when working on the rear wheel (as shown in diagram 200), recommendation module 110 may recommend a stylistic change 306 for changing wheel 304. For example, change 306 may involve unscrewing bolts in a counterclockwise direction 308 (considering that crew member 204b consistently uncrewed bolts in a clockwise direction).

Classification module 106 and error detection module 108 may be configured to determine whether the recommended changes are actually implemented by the crew members. For example, when crew member 204b is changing wheel 304, error detection module 108 may flag an error if the direction of the unscrewing does not match direction 308 as indicated in change 306. If the recommendation is actually implemented, error detection module 108 may determine whether the recommendation reduced the error and/or minimized service time in the next threshold number of services.

For example, recommendation module 110 may consider performance over a certain period of time/number of services. Suppose that recommendation module 110 analyzes performance over 50 services. After a change is implemented, the effectiveness of the recommendation is evaluated over another threshold number of services (e.g., 10 services) or threshold period of time (e.g., 1 week). During this time, error detection module 108 determines whether there is any performance issue in the car, any reduction/increase in average service time, any reduction/increase in average errors.

It should be noted that that errors vary in importance. Error detection module 108 may assign a respective importance value to a respective error based on a combination of how severe the delays it causes, the monetary loss it may cause, and the safety issues it poses. For example, an error involving a jack being dropped near the car may be assigned an importance rating of 2/10 (where 10/10 is the highest importance and 1/10 is the lowest importance). In contrast to this low importance value, error detection module 108 may assign 8/10 to a dropped fuel gun because the car may require fuel to run, the fuel gun may need replacement, and any leaked fuel may cause an environmental hazard.

Error detection module 108 may include another machine learning algorithm for assigning importance values. The machine learning algorithm may be trained with supervised learning where a dataset is manually curated and includes importance values and the associated delay times, monetary loss values, and/or safety codes associated with potential hazards.

Accordingly, when determining whether a recommended change is effective, recommendation module 110 may monitor whether the average importance value of errors has decreased.

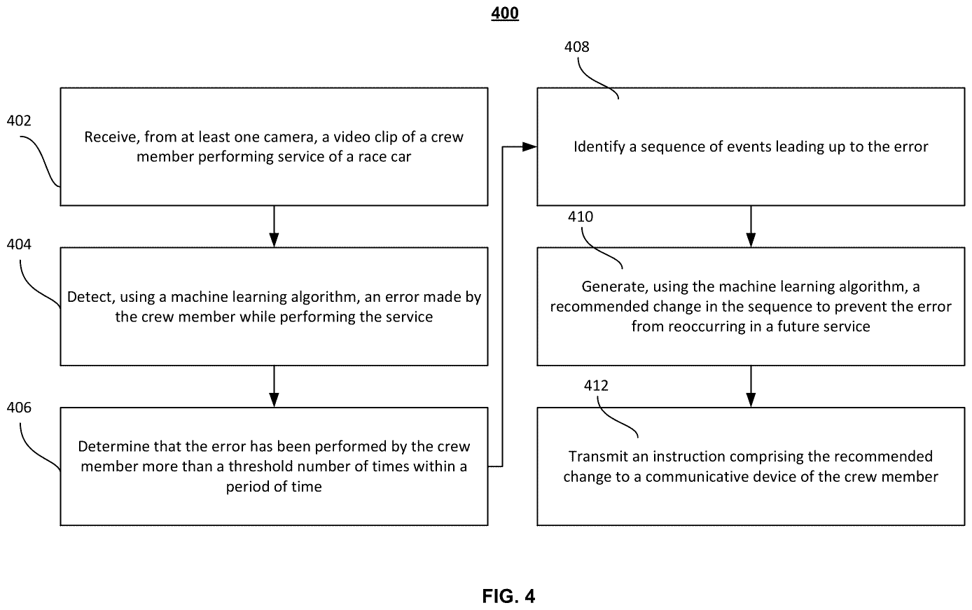

FIG. 4 is a flow diagram of method 400 for machine learning based analysis of a race car pit crew. At 402, machine learning module 105 receives, from at least one camera, a video clip of a crew member performing service of a race car.

At 404, machine learning module 105 detect, using a machine learning algorithm, an error made by the crew member while performing the service. In some aspects, machine learning module 105 detects the error by detecting one or more of: a malfunctioning tool, a dropped tool, an injury, improper placement of car part, improper positioning of the crew member, improper positioning of the race car. In some aspects, the machine learning algorithm is configured to detect a plurality of objects in the video clip, wherein the objects comprise one or more of the race car, a car part of the race car, the crew member, a tool used by the crew member.

At 406, machine learning module 105 determining that the error has been performed by the crew member more than a threshold number of times within a period of time. At 408, machine learning module 105 identifies a sequence of events leading up to the error. At 410, machine learning module 105 generates, using the machine learning algorithm, a recommended change in the sequence to prevent the error from reoccurring in a future service. In some aspects, the machine learning algorithm comprises a large language model that outputs the recommended change in a text format. In some aspects, the recommended change comprises one or more of: a tool change, a positional change, a technique change, a crew member reassignment, a crew member replacement, an exercise.

At 412, machine learning module 105 transmits an instruction comprising the recommended change to a communicative device of the crew member. In some aspects, the recommended change is visually output on the communicative device as one of an augmented reality object, virtual reality object, or a mixed reality object.

In some aspects, the crew member is presented with a plurality of instructions to perform the service, and wherein transmitting the instruction comprises one of communication module 114 replacing an existing instruction in the plurality of instructions with the instruction, communication module 114 adding the instruction to the plurality of instructions, or communication module 114 modifying the existing instruction to match the instruction.

In some aspects, machine learning module 105 detects whether the recommended change is executed by the crew member in the future service of the race car. Machine learning module 105 then evaluates whether the error was made by the crew member, in response to determining that the error was made again by the crew member, generating another recommended change.

FIG. 5 is a block diagram illustrating a computer system 20 on which aspects of systems and methods for monitoring race car pit crews and generating optimization recommendations may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-4 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for machine learning based analysis of race car pit crew, the method comprising:
receiving, from at least one camera, a video clip of a crew member performing service of a race car;
detecting, using a machine learning algorithm, an error made by the crew member while performing the service;
in response to determining that the error has been performed by the crew member more than a threshold number of times within a period of time, identifying a sequence of events leading up to the error;
generating, using the machine learning algorithm, a recommended change in the sequence to prevent the error from reoccurring in a future service; and
transmitting an instruction comprising the recommended change to a communicative device of the crew member.

2. The method of claim 1, wherein the machine learning algorithm comprises a large language model that outputs the recommended change in a text format.

3. The method of claim 1, wherein the recommended change is visually output on the communicative device as one of an augmented reality object, virtual reality object, or a mixed reality object.

4. The method of claim 1, wherein detecting the error comprises detecting one or more of: a malfunctioning tool, a dropped tool, an injury, improper placement of car part, improper positioning of the crew member, improper positioning of the race car.

5. The method of claim 1, wherein the machine learning algorithm is configured to detect a plurality of objects in the video clip, wherein the objects comprise one or more of the race car, a car part of the race car, the crew member, a tool used by the crew member.

6. The method of claim 1, wherein the crew member is presented with a plurality of instructions to perform the service, and wherein transmitting the instruction comprises one of:
replacing an existing instruction in the plurality of instructions with the instruction;
adding the instruction to the plurality of instructions; or
modifying the existing instruction to match the instruction.

7. The method of claim 1, further comprising:
detecting whether the recommended change is executed by the crew member in the future service of the race car;
evaluating whether the error was made by the crew member; and
in response to determining that the error was made again by the crew member, generating another recommended change.

8. The method of claim 1, wherein the recommended change comprises one or more of: a tool change, a positional change, a technique change, a crew member reassignment, a crew member replacement, an exercise.

9. A system for machine learning based analysis of race car pit crew, comprising:
at least one memory;
at least one hardware processor coupled with the at least one memory and configured, individually or in combination, to:
receive, from at least one camera, a video clip of a crew member performing service of a race car;
detect, using a machine learning algorithm, an error made by the crew member while performing the service;
in response to determining that the error has been performed by the crew member more than a threshold number of times within a period of time, identify a sequence of events leading up to the error;
generate, using the machine learning algorithm, a recommended change in the sequence to prevent the error from reoccurring in a future service; and
transmit an instruction comprising the recommended change to a communicative device of the crew member.

10. The system of claim 9, wherein the machine learning algorithm comprises a large language model that outputs the recommended change in a text format.

11. The system of claim 9, wherein the recommended change is visually output on the communicative device as one of an augmented reality object, virtual reality object, or a mixed reality object.

12. The system of claim 9, wherein detecting the error comprises detecting one or more of: a malfunctioning tool, a dropped tool, an injury, improper placement of car part, improper positioning of the crew member, improper positioning of the race car.

13. The system of claim 9, wherein the machine learning algorithm is configured to detect a plurality of objects in the video clip, wherein the objects comprise one or more of the race car, a car part of the race car, the crew member, a tool used by the crew member.

14. The system of claim 9, wherein the crew member is presented with a plurality of instructions to perform the service, and wherein transmitting the instruction comprises one of:
replacing an existing instruction in the plurality of instructions with the instruction;
adding the instruction to the plurality of instructions; or
modifying the existing instruction to match the instruction.

15. The system of claim 9, further comprising:
detecting whether the recommended change is executed by the crew member in the future service of the race car;
evaluating whether the error was made by the crew member; and
in response to determining that the error was made again by the crew member, generating another recommended change.

16. The system of claim 9, wherein the recommended change comprises one or more of: a tool change, a positional change, a technique change, a crew member reassignment, a crew member replacement, an exercise.

17. A non-transitory computer readable medium storing thereon computer executable instructions for machine learning based analysis of race car pit crew, including instructions for:
receiving, from at least one camera, a video clip of a crew member performing service of a race car;
detecting, using a machine learning algorithm, an error made by the crew member while performing the service;
in response to determining that the error has been performed by the crew member more than a threshold number of times within a period of time, identifying a sequence of events leading up to the error;
generating, using the machine learning algorithm, a recommended change in the sequence to prevent the error from reoccurring in a future service; and
transmitting an instruction comprising the recommended change to a communicative device of the crew member.
